(19) United States
(12) Patent Application Publication
(10) Pub. No.: US 2015/0243211 A1
(43) Pub. Date: Aug. 27, 2015

(54) DISPLAY DEVICE AND DRIVING METHOD THEREOF

(71) Applicant: SAMSUNG DISPLAY CO., LTD., Yongin-City (KR)

(72) Inventor: Dong-Hak Pyo, Hwaseong-si (KR)

(21) Appl. No.: 14/475,515

(22) Filed: Sep. 2, 2014

(30) Foreign Application Priority Data
Feb. 25, 2014 (KR) 10-2014-0022067

(51) Int. Cl. G09G 3/32

(52) U.S. Cl. CPC G09G 3/3216; G09G 2330/028; G09G 2330/021

(57) ABSTRACT

A display device includes: a display unit including pixels; a scan driver configured to provide scan signals to the pixels; a data driver configured to provide data signals to the pixels; a power supply configured to supply a driving power to the pixels; and a controller configured to transmit scan control signals, data control signals, and power control signals for controlling the scan signals, the data signals, and the driving power, respectively. The controller includes: a power consumption calculator configured to calculate power consumption of image data forming a frame; a maximum gray value calculator configured to calculate a maximum gray value of the image data forming the frame; and a voltage level determining unit configured to adjust a voltage level of the driving power in accordance with the maximum gray value, when the calculated power consumption is higher than a reference value.

### CROSS-REFERENCE TO RELATED APPLICATION

This application claims priority to and the benefit of Korean Patent Application No. 10-2014-0022067, filed on Feb. 25, 2014, with the Korean Intellectual Property Office, the disclosure of which is incorporated herein in its entirety by reference.

### BACKGROUND

1. Field

Aspects of embodiments of the present invention relate to a display device having improved image quality and a driving method thereof.

2. Description of the Related Art

In general, a display device includes a plurality of pixels provided in an area defined by a black matrix or a pixel defining layer. The display device is categorized into a liquid crystal display (LCD), a plasma display panel (PDP), an organic light emitting display (e.g., an organic light emitting diode (OLED) display), and the like based on the type of emissions.

The recent trend of a large-size and high-resolution display device requires increased power consumption. More particularly, the organic light emitting display uses self-emission elements, and therefore consumes more power. Accordingly, there has been increased emphasis on algorithm development to reduce power consumption of the organic light emitting display.

In order to reduce the power consumption, there are, for example, a method of reducing current supplied to the display device and a method of reducing voltage supplied to the display device. In a case where the method of reducing voltage supplied to the display device is used, the voltage applied to the display device is determined in accordance with a maximum gray value of the plurality of pixels.

That is, the gray values of the plurality of the pixels are compared for each frame to determine the maximum gray value, and a voltage level of a driving power ELVDD applied to the corresponding frame is determined accordingly. Therefore, a high-level driving voltage may be applied to the frame having a high maximum gray value, while a low-level driving voltage may be applied to the frame having a low maximum gray value.

Such a method can reduce the power consumption compared to a conventional driving method where a constant driving power is applied regardless of gray-scale and luminance. However, in a case where overall luminance of a display image is dim, the luminance of the display image may be changed due to a voltage level difference of the applied driving power, and this phenomenon is called a flickering effect.

FIG. 1 shows conceptual images illustrating a case where overall luminance of a display image is low (e.g., an average gray value of 10), and a series of frames a and b have maximum gray values of a: 255 and b: 100 respectively.

Referring to FIG. 1, a driving voltage of 15V is applied to the a-frame having the maximum gray value of 255, while a driving voltage of 11.16V is applied to the b-frame having the maximum gray value of 100. In other words, even though frames have the same average gray value, the frames can have different luminance levels because different driving voltages are applied to each frame of the series of frames.

Such a luminance change is significantly noticeable in a case where the display image has a low overall luminance level, because low luminance level is likely to lead to changes in the voltage levels of the driving power ELVDD, and even with data correction, data quantization in the process of correction causes more errors than before correction.

### SUMMARY

Aspects of embodiments of the present invention are directed to a display device capable of reducing power consumption and preventing or reducing deterioration of image quality and to a driving method thereof.

According to an embodiment of the present invention, a display device includes: a display unit including a plurality of pixels; a scan driver configured to provide scan signals to the plurality of pixels; a data driver configured to provide data signals to the plurality of pixels; a power supply configured to supply a driving power to the plurality of pixels; and a controller coupled to each of the scan driver, the data driver, and the power supply, and configured to generate and transmit scan control signals, data control signals, and power control signals for controlling the scan signals, the data signals, and the driving power, respectively, the controller including: a power consumption calculator configured to calculate power consumption of image data forming a frame; a maximum gray value calculator configured to calculate a maximum gray value of the image data forming the frame; and a voltage level determining unit configured to adjust a voltage level of the driving power in accordance with the maximum gray value, when the calculated power consumption is higher than a reference value.

The voltage level determining unit may be configured to increase the voltage level of the driving power, as the maximum gray value increases, when the calculated power consumption of the frame is higher than the reference value.

The voltage level determining unit may be configured to maintain the voltage level of the driving power, when the calculated power consumption of the frame is lower than the reference value.

The voltage level determining unit may be configured to decrease the voltage level of the driving power in a high power-consumption pattern, when the maximum gray values are the same.

The display device may further include a power controller configured to control the power supply in accordance with voltage level signals applied from the voltage level determining unit.

According to an embodiment of the present invention, a method of driving a display device including a plurality of pixels, a power supply configured to supply a driving power to the plurality of pixels, and a controller configured to generate power control signals for controlling the driving power is provided, the method including: analyzing image data on a frame by frame basis; generating power control signals in accordance with the analyzed image data; and supplying the driving power adjusted in accordance with the generated power control signals to the plurality of pixels.

The analyzing the image data may include: calculating power consumption of the image data forming a frame; calculating a maximum gray value of the image data forming the frame; and determining a voltage level of the driving power based on the calculated power consumption and maximum gray value.

The determining of the voltage level of the driving power may include adjusting the voltage level of the driving power in accordance with the maximum gray value, when the calculated power consumption is higher than a reference value.

The adjusting of the voltage level of the driving power may include increasing the voltage level of the driving power as the maximum gray value increases.

The adjusting of the voltage level of the driving power may include decreasing the voltage level of the driving power in a high power-consumption pattern, when the maximum gray values are the same.

The determining of the voltage level of the driving power may include maintaining the voltage level of the driving power, when the calculated power consumption is lower than a reference value.

According to aspects of embodiments of the present invention, the display device and the driving method thereof may calculate the desired power consumption for each frame, and adjust the voltage level of the driving voltage in accordance with the power consumption, thereby reducing the power consumption and preventing or reducing deterioration of image quality.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The above and other features and aspects of the present invention will be more clearly understood from the following detailed description taken in conjunction with the accompanying drawings, in which:

FIG. 1 shows conceptual images for illustrating a conventional algorithm for adjusting a voltage level of a driving power;

FIG. 2 is a schematic block diagram showing a display device according to an embodiment of the present invention;

FIG. 3 is a circuit diagram showing a pixel of the display device according to an embodiment of the present invention;

FIG. 4 is a schematic block diagram showing a control unit according to an embodiment of the present invention;

FIG. 5 is a schematic block diagram showing an image analyzing unit according to an embodiment of the present invention;

FIG. 6 is a table showing voltage levels in accordance with power consumption and maximum gray values;

FIG. 7 shows conceptual images for illustrating a driving method of a low power-consumption pattern according to an embodiment of the present invention;

FIG. 8 shows conceptual images for illustrating a driving method of a high power-consumption pattern according to an embodiment of the present invention;

FIG. 9 is a graph illustrating a difference in power consumption between a case where an algorithm for adjusting the voltage level according to an embodiment of the present invention is applied and a case where the conventional algorithm for adjusting the voltage level is applied.

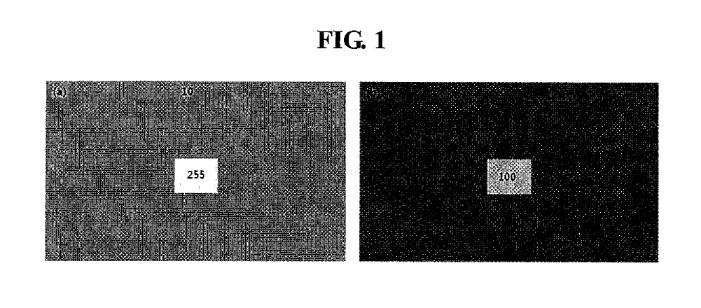

### DETAILED DESCRIPTION

Hereinafter, embodiments of the present invention will be described in more detail with reference to the accompanying drawings.

Although the present invention can be modified in various manners and have several embodiments, specific embodiments are illustrated in the accompanying drawings and will be mainly described in the specification. However, the spirit and scope of the present invention is not limited to the specific embodiments described herein, and should be construed as including all the changes, equivalents, and substitutions included within the spirit and scope of the present invention.

Throughout the specification, when an element is referred to as being “connected” or “coupled” to another element, the element may be “directly connected” to the other element, or “electrically connected” or “indirectly connected” to the other element through one or more intervening elements. It will be further understood that the terms “comprises,” “comprising,” “includes,” and “including,” when used in this specification, specify the presence of the stated features, integers, steps, operations, elements, components, and groups thereof, but do not preclude the presence or addition of one or more other features, integers, steps, operations, elements, components, and groups thereof.

It will be understood that, although the terms “first,” “second,” “third,” and the like may be used herein to describe various elements, these elements should not be limited by these terms. These terms are only used to distinguish one element from another element. Thus, “a first element” discussed below could be termed “a second element” or “a third element,” and “a second element” and “a third element” can be termed likewise, without departing from the spirit and scope of the present invention.

In this specification, the description of some parts which are not necessary to those of skill in the art for a complete understanding of the present invention have been omitted, and like reference numerals refer to like elements throughout the specification.

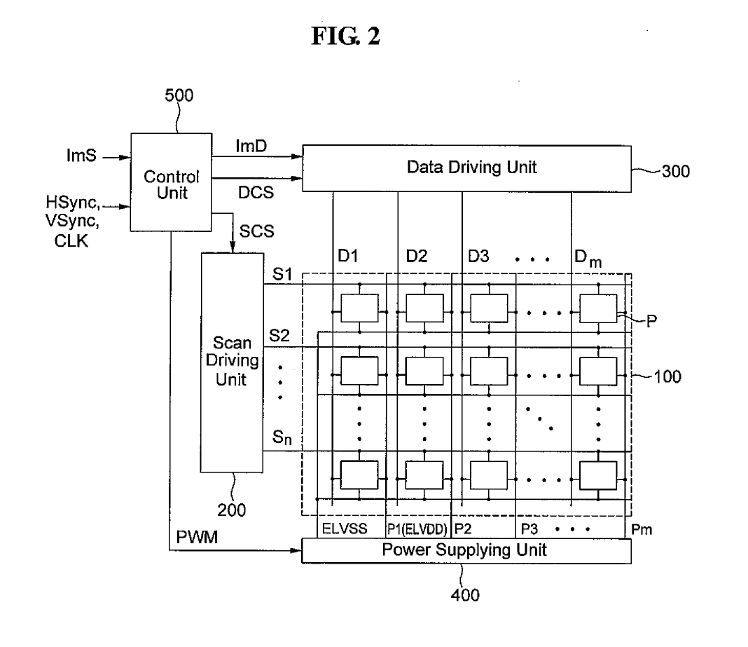

FIG. 2 is a schematic block diagram showing a display device according to an embodiment of the present invention.

Referring to FIG. 2, according to an embodiment of the present invention, a display device includes a display unit 100, a scan driving unit 200 (e.g., a scan driver), a data driving unit 300 (e.g., a data driver), a power supplying unit 400 (e.g., a power supply), and a control unit 500 (e.g., a controller).

The display unit 100 includes a plurality of scan lines S1˜Sn, a plurality of data lines D1˜Dm, a plurality of pixels P provided in an area defined by the scan lines and the data lines D1˜Dm, and a plurality of power lines P1˜Pm for supplying driving voltages to the plurality of pixels P. The scan lines S1˜Sn extend in a row direction and are parallel or substantially parallel to one another, while the data lines D1˜Dm and power lines P1˜Pm extend in a column direction and are parallel or substantially parallel to one another.

The scan driving unit 200 sequentially generates scan signals in accordance with scan control signals SCS applied from the control unit 500, and sequentially transmits the scan signals to the plurality of scan lines S1˜Sn.

The data driving unit 300 sequentially transmits image data ImD, provided from the control unit 500, to the plurality of data lines D1˜Dm in accordance with data control signals DCS applied from the control unit 500.

The power supplying unit 400 is configured to adjust voltage levels of the driving powers ELVDD and ELVSS in accordance with power control signals applied from the control unit 500, and to transmit the adjusted driving powers to the power lines P1˜Pm. The power control signals may include, for example, a pulse width modulated signal PWM. The pulse width modulated signal PWM can adjust the voltage levels of the driving power applied from the power supplying unit 400 by varying duty ratios.

The control unit 500 is connected to the scan driving unit 200, the data driving unit 300, and the power supplying unit 400. The control unit 500 is configured to receive image signals ImS, synchronization signals Hsync and Vsync, and clock signals CLK from the outside, and to generate control signals for controlling the scan driving unit 200, the data driving unit 300, and the power supplying unit 400.

The image signals ImS applied from the outside contain luminance information of each pixel P. Each luminance value has a number of gray levels (e.g., a predetermined number of gray levels or gray values), for example, 1024 (=2¹⁰), 256 (=2⁸), 64 (=2⁶), etc. In other words, the image signals ImS include gray-scale data.

Each of the scan driving unit 200, the data driving unit 300, the power supplying unit 400, and the control unit 500 may be provided in a form of an integrated circuit chip disposed directly on the display unit 100, on a flexible printed circuit layer, or on a separate printed circuit board. Otherwise, each of the scan driving unit 200, the data driving unit 300, the power supplying unit 400, and the control unit 500 may be integrated into the display unit 100 with the various signal lines S1˜Sn and D1˜Dm.

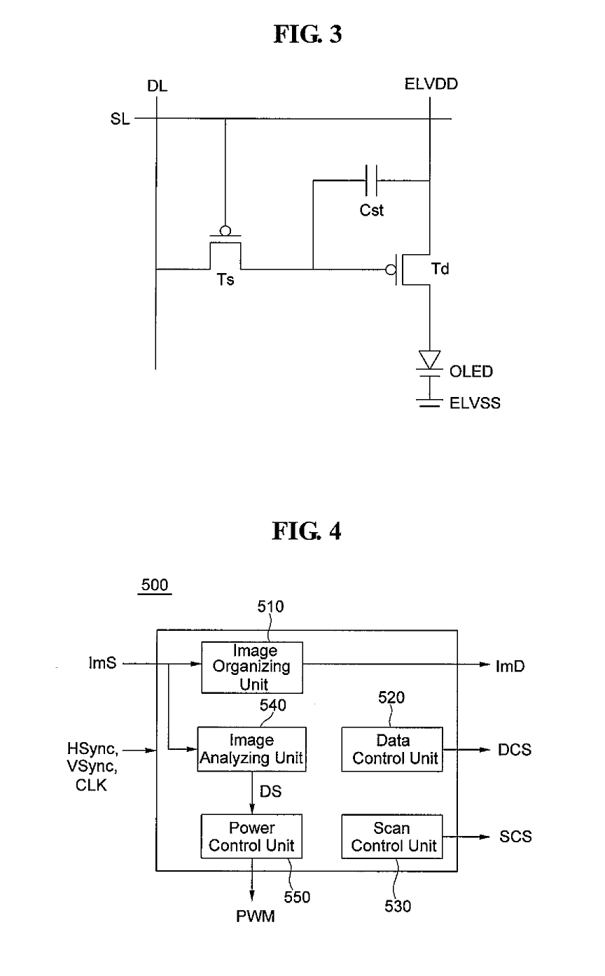

FIG. 3 is a circuit diagram showing a pixel according to an embodiment of the present invention.

Referring to FIG. 3, a pixel P may include an organic light emitting diode (OLED), a switching transistor Tₛ configured to be turned on by the scan signals applied from the scan line SL to transmit data signals, a storage capacitor Cₛₜ for being charged to a voltage value corresponding to the transmitted data signals, and a driving transistor T_{d} for controlling a current amount flowing to the OLED in accordance with the voltage charged in the storage capacitor.

A gate electrode of the driving transistor T_{d} is connected to a terminal at one end of the storage capacitor Cₛₜ, a first electrode of the driving transistor T_{d} is connected to a terminal at the other end of the storage capacitor Cₛₜ and the driving power ELVDD, and a second electrode of the driving transistor T_{d} is connected to the OLED. The OLED generates light having luminance in accordance with the amount of current supplied via the driving transistor T_{d}.

Therefore, the driving transistor T_{d} controls a current amount flowing from the driving power ELVDD to the OLED in accordance with a gate-source voltage V_{gs} of the driving transistor T_{d} (namely, the voltage value corresponding to the data signal).

Therefore, the driving power ELVDD should have a higher voltage level than the gate-source voltage V_{gs} of the driving transistor T_{d}. In other words, a maximum voltage level of the driving power ELVDD may vary in accordance with the data signals inputted to the driving transistor T_{d}.

In FIG. 3, the pixel P is depicted as having a 2Tr1C (e.g., 2 transistors and 1 capacitor) structure. However, the present invention is not limited thereto, and thus, the pixel P may further include additional transistors for compensating a threshold voltage and initiating the driving transistor T_{d}, and may further receive compensation signals for driving the additional transistors. In addition, in FIG. 3, the transistors forming the pixel P are depicted as PMOS transistors. However, the present invention is not limited thereto, and thus, the transistors forming the pixel P may be NMOS transistors.

FIG. 4 is a schematic block diagram showing a control unit according to an embodiment of the present invention.

Referring to FIG. 4, according to an embodiment of the present invention, a control unit 500 (e.g., a controller) includes an image organizing unit 510 (e.g., an image organizer), a data control unit 520 (e.g., a data controller), a scan control unit 530 (e.g., a scan controller), an image analyzing unit 540 (e.g., an image analyzer), and a power control unit 550 (e.g., a power controller).

The image organizing unit 510 is configured to convert the data signals ImS containing image information provided from an external device to image data ImD, and to transmit the image data to the data driving unit 300.

The data control unit 520 is configured to generate the data control signals DCS in accordance with the synchronization signals Hsync and Vsync and the clock signal CLK, and to transmit the data control signals to the data driving unit 300.

The scan control unit 530 is configured to generate the scan control signals SCS in accordance with the synchronization signals Hsync and Vsync and the clock signals CLK applied from the external device, and to transmit the scan control signals to the scan driving unit 200.

The image analyzing unit 540 is configured to analyze the data signals ImS containing the image information provided from the external device on a frame by frame basis, and to generate duty control signals DS based on the analyzed data to transmit to the power control unit 550 described below. The image analyzing unit 540 calculates the power consumption and the maximum gray value of the image data forming a frame, and determines the voltage level of the driving power ELVDD based on the calculated power consumption and the maximum gray value. A detailed configuration of the image analyzing unit 540 will be described below.

The power control unit 550 is configured to output the power control signals for controlling the power supplying unit 400 (refer to FIG. 2) in accordance with the duty control signals DS determined by the image analyzing unit 540, and to control the duty ratios of the voltage levels of the driving power ELVDD. The power control signals may include, for example, the pulse width modulated signal PWM. The pulse width modulated signal PWM can adjust voltage levels of the driving power ELVDD applied from the power supplying unit 400 by varying duty ratios.

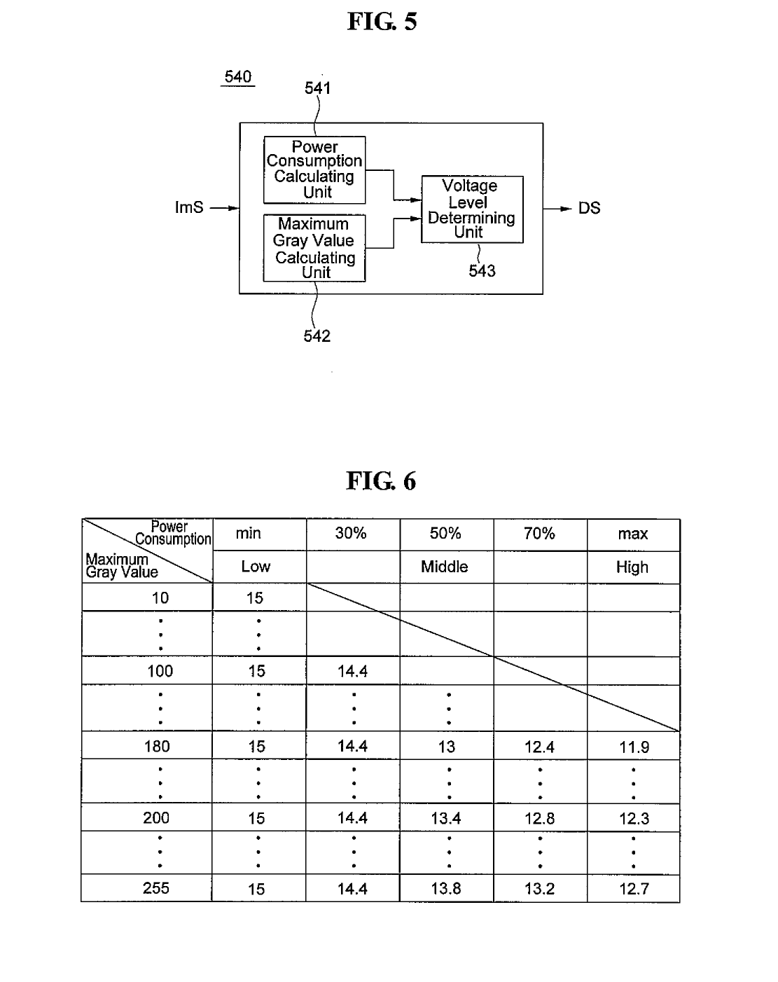

FIG. 5 is a schematic block diagram showing an image analyzing unit according to an embodiment of the present invention.

Referring to FIG. 5, according to an embodiment of the present invention, the image analyzing unit 540 (e.g., image analyzer) includes a power consumption calculating unit 541 (e.g., a power consumption calculator) for calculating the power consumption of the image data forming a frame, a maximum gray value calculating unit 542 (e.g., a maximum gray value calculator) for calculating the maximum gray value of the image data forming the frame, and a voltage level determining unit 543 for determining voltage levels of the driving power based on the power consumption and the maximum gray value of the frame calculated by the power consumption calculating unit 541 and the maximum gray value calculating unit 542.

The power consumption calculating unit 541 is configured to calculate the power consumption of the image data forming the frame. That is, the amount of power consumption required for the image data applied to the plurality of pixels P is calculated on a frame by frame basis. In this case, the calculated amount reflects calculated power consumption, and not actual power consumption.

For example, the power consumption calculating unit 541 may use image data values (e.g., gray values or gray levels) provided to each pixel in order to calculate the power consumption of each frame. Therefore, the power consumption of each frame can be calculated based on the gray values of the plurality of corresponding pixels. For example, in a case where an image signal has a gray value of 256 (=2⁸), given that all the pixels forming a frame have a gray value of 255, the frame has a maximum power consumption value (max_power). On the contrary, if all the pixels forming a frame have a gray value of 1, the frame has a minimum power consumption value (min_power).

In other words, the power consumption calculating unit 541 can calculate an expected power consumption value based on each gray value of all the pixels forming a frame. Therefore, the power consumption calculating unit 541 can provide the amount of power consumption of the corresponding frame based on the max_power or the min_power.

The maximum gray value calculating unit 542 is configured to calculate a maximum gray value of image data forming a frame. That is, a maximum value among gray values of the plurality of pixels forming the frame is calculated.

A voltage level determining unit 543 is configured to determine the voltage level of the driving power based on the power consumption and the maximum gray value of the frame calculated by the power consumption calculating unit 541 and the maximum gray value calculating unit 542.

In a case where the power consumption value calculated by the power consumption calculating unit 541 is lower than a reference value, the voltage level determining unit 543 can output a control signal for maintaining the voltage level of the driving power.

On the contrary, in a case where the power consumption value calculated by the power consumption calculating unit 541 is higher than the reference value, the voltage level determining unit 543 can output a control signal for adjusting the voltage level of the driving power ELVDD in accordance with the maximum gray value calculated by the maximum gray value calculating unit 542.

For example, in a case where the power consumption value calculated by the power consumption calculating unit 541 is higher than the reference value, as the maximum gray value calculated by the maximum gray value calculating unit 542 increases, the voltage level of the driving power ELVDD is increased. On the contrary, as the maximum gray value calculated by the maximum gray value calculating unit 542 decreases, the voltage level of the driving power ELVDD is reduced.

The reference value can be determined based on the max_power, on the condition that all the pixels have a maximum gray-scale (for example, when all the pixels have the 255 gray levels). For example, according to an embodiment of the present invention, the reference value may be determined to be at 30% of the max_power. Hereinafter, for ease of description, the power consumption values calculated by the power consumption calculating unit 541 are classified into three power-consumption patterns: a low power-consumption pattern which has power consumption of less than 30% of the max_power; a medium power-consumption pattern which has power consumption of greater than or equal to 30% and less than or equal to 70% of the max_power; and a high power-consumption pattern which has power consumption of greater than 70% of the max_power.

Accordingly, in a case where a power consumption value calculated by the power consumption calculating unit 541 is lower than 30% of the max_power, the voltage level determining unit 543 may generate a control signal for maintaining a voltage level of the driving power ELVDD.

Further, in a case where a power consumption value calculated by the power consumption calculating unit 541 is higher than 30% of the max_power, the voltage level determining unit 543 may generate a control signal for adjusting the voltage level of the driving power ELVDD in accordance with the maximum gray value calculated by the maximum gray value calculating unit 542.

In other words, an embodiment of the present invention provides a driving method in which the reference value is set, and accordingly, the power-consumption pattern that is higher than the reference value changes the voltage level of the driving power, and the power-consumption pattern that is lower than the reference value maintains the voltage level of the driving power. Consequently, image quality deterioration observed in a low luminance environment (e.g., the low power-consumption pattern) can be improved.

In addition, the voltage level determining unit 543 may determine the voltage level of the driving power according to voltage levels in a lookup table that are set (e.g., predetermined) in accordance with the power consumption and the maximum gray value.

FIG. 6 is a table showing voltage levels in accordance with power consumption and maximum gray values. In more detail, FIG. 6 is an example of a lookup table showing the voltage levels in accordance with the power consumption and the maximum gray values, provided that the reference value is 30% of the max_power. In FIG. 6, a horizontal axis represents the power consumption calculated by the power consumption calculating unit, while a vertical axis represents the maximum gray values calculated by the maximum gray level calculating unit.

For example, the low power-consumption pattern has power consumption of less than 30% of the max_power, a medium power-consumption pattern has power consumption of greater than or equal to 30% and less than or equal to 70% of the max_power, and a high power-consumption pattern has power consumption of greater than 70% of the max_power.

Referring to FIG. 6, in a case where the power consumption value calculated by the power consumption calculating unit 541 is lower than 30% of the max_power, the voltage level determining unit 543 outputs a constant voltage level regardless of the maximum gray value. Further, when the power consumption calculated by the power consumption calculating unit 541 is higher than 30% of the max_power, the voltage level determining unit 543 outputs a voltage level in accordance with the maximum gray value.

In other words, in a case where the power consumption value is higher than 30% of the max_power, as the maximum gray value increases, the voltage level of the driving power ELVDD is increased, whereas as the maximum gray value decreases, the voltage level of the driving power ELVDD is reduced.

On the other hand, there is another driving method where power consumption of the display device is more limited in the high power-consumption pattern, on a condition that the maximum gray values are the same. For example, in order to limit the power consumption of the display device, in a case where image data corresponding to a maximum power-consumption pattern (e.g., where all the pixels forming a frame have a gray value of 255) is inputted to the pixels, the voltage level determining unit 543 outputs a voltage control signal corresponding to 255*0.3=76.5 gray levels to the power control unit 550 to control the driving power ELVDD.

Accordingly, the power control unit 550 lowers the voltage level of the driving power ELVDD outputted from the power supplying unit 400 to 12.7V, in order to limit the power consumption.

In other words, as illustrated in FIG. 6, in a case where the maximum gray value is 255 and the maximum power consumption value is 100%, the voltage value of the driving power ELVDD is 12.7V, while in a case where the maximum gray value is 255 and the maximum power consumption value is 70%, the voltage value of the driving power ELVDD is 13.2V.

According to a driving method of an embodiment of the present invention, in a case where the high power-consumption pattern is provided, the driving power ELVDD has a voltage level lower than the original voltage level of 15V, while in a case where the low power-consumption pattern is provided, a voltage level of the driving power ELVDD remains about the same. As a result, in a case where the high power-consumption pattern is provided, a large amount of current is reduced in the pixel, such that the power consumption can be more reduced compared to the low power-consumption pattern.

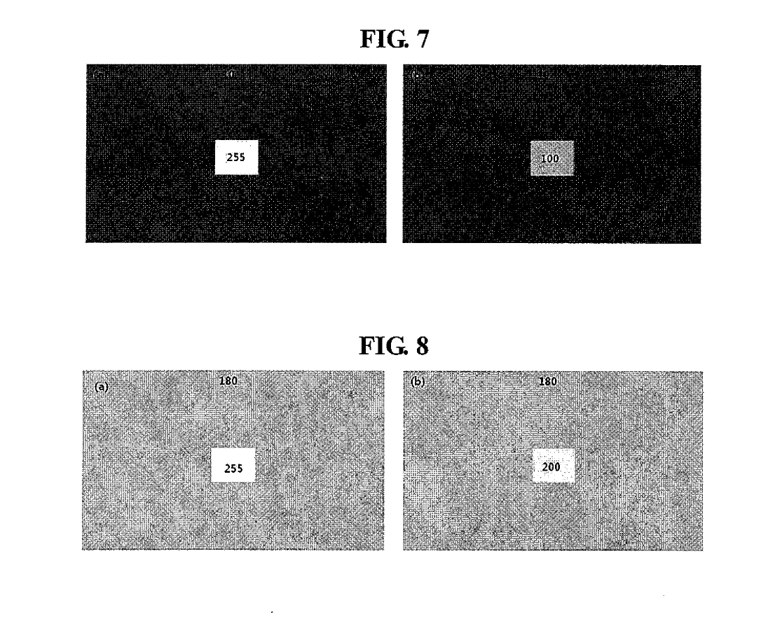

FIG. 7 shows conceptual images for illustrating a driving method of the low power-consumption pattern according to an embodiment of the present invention. In more detail, FIG. 7 is images illustrating a case where the low power-consumption pattern is provided (e.g., an average gray value of 10) and a series of frames a and b having maximum gray values of a: 255 and b: 100, respectively.

According to an embodiment of the present invention, in a case of the low power-consumption pattern, a driving voltage of 15V may be applied to both of the frames a and b, regardless of the maximum gray values. That is, a constant voltage level of the driving power leads to a constant luminance level, such that a flickering phenomenon can be prevented or reduced.

On the contrary, according to a conventional driving method, the frame a has a maximum gray value of 255, and thus a driving voltage of 15V may be applied to the frame a, whereas the frame b has a maximum gray value of 100, and thus a driving voltage of 12.57V may be applied to the frame b.

Thus, in a case of the low power-consumption pattern according to a conventional driving method, a maximum gray value difference can lead to a large voltage level difference (15V→12.57V, voltage variation: 2.43V) of the driving power. However, an amount of current consumption is low, and thus an actual decrease in the power consumption is measured to be 0˜0.6%, thereby showing only a small decrease in power consumption. Further, as a luminance variation in accordance with the voltage variation of the driving power increases, the flickering phenomenon is likely to occur.

FIG. 8 shows conceptual images for illustrating a driving method of the high power-consumption pattern according to an embodiment of the present invention. In more detail, FIG. 8 shows images illustrating a case where the high power-consumption pattern is provided (e.g., an average gray value of 180), and a series of frames a and b have maximum values of a: 255 and b: 200, respectively.

Referring to FIGS. 6 and 8, in a case of the high power-consumption pattern, a driving power of 12.7V may be applied to the frame a, while a driving power of 12.3V may be applied to the frame b.

Therefore, in a case of the high power-consumption pattern, a voltage level difference (12.7→12.3V, voltage variation: 0.4V) of the driving power in accordance with the maximum gray value difference is smaller when compared to the low power-consumption pattern.

Accordingly, a small luminance variation is produced, and thus the flickering phenomenon is not often observed. However, an amount of current is largely decreased in the pixel, such that a decrease in the power consumption is large when compared to the low power-consumption pattern. That is, a large amount of current is consumed in a high power-consumption pattern, and thus an actual decrease in the power consumption is measured to be 4.6%→5.3%.

Consequently, referring to FIGS. 7 and 8, the flickering phenomenon can be significantly reduced, on a condition that the voltage level of the driving power is maintained in the low power-consumption pattern and that the voltage level of the driving power is adjusted in accordance with the maximum gray value in the high power-consumption pattern.

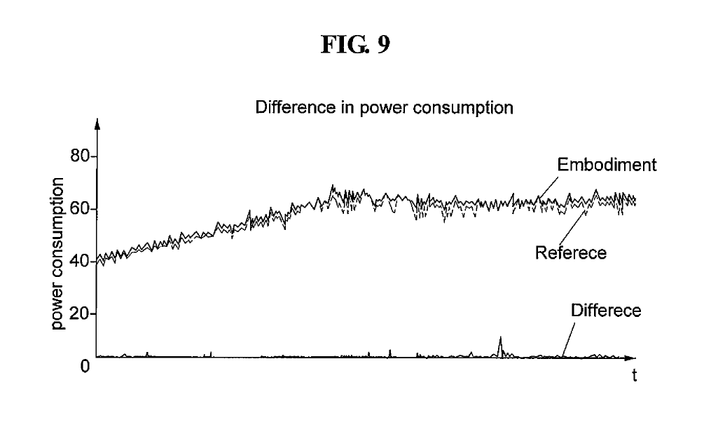

FIG. 9 is a graph illustrating a difference in power consumption between a case where a driving method of adjusting the voltage level according to an embodiment of the present invention is applied and a case where a conventional driving method of adjusting the voltage level is applied.

In more detail, FIG. 9 is a graph illustrating a decrease in power consumption in a case where a driving method of adjusting the voltage level according to an embodiment of the present invention is applied to a video data having a reference power consumption level compared to a case where a conventional driving method of adjusting the voltage level is applied to the video data.

Referring to FIG. 9, according to the driving method of an embodiment of the present invention, the power consumption is increased by about 0.4% when compared to the conventional algorithm. In other words, there does not appear to be a noticeable increase in power consumption, however, the flickering phenomenon can be prevented or reduced in the low power-consumption pattern.

From the foregoing, it will be appreciated that various embodiments of the present disclosure have been described herein for purposes of illustration, and that various modifications may be made without departing from the scope and spirit of the present invention. Accordingly, the various embodiments disclosed herein are not intended to be limiting, with the true scope and spirit being indicated by the following claims, and equivalents thereof.

What is claimed is:

1. A display device comprising:
a display unit comprising a plurality of pixels;
a scan driver configured to provide scan signals to the plurality of pixels;
a data driver configured to provide data signals to the plurality of pixels;
a power supply configured to supply a driving power to the plurality of pixels; and
a controller coupled to each of the scan driver, the data driver, and the power supply, and configured to generate and transmit scan control signals, data control signals, and power control signals for controlling the scan signals, the data signals, and the driving power, respectively, the controller comprising:
a power consumption calculator configured to calculate power consumption of image data forming a frame;
a maximum gray value calculator configured to calculate a maximum gray value of the image data forming the frame; and
a voltage level determining unit configured to adjust a voltage level of the driving power in accordance with the maximum gray value, when the calculated power consumption is higher than a reference value.

2. The display device of claim 1, wherein the voltage level determining unit is configured to increase the voltage level of the driving power, as the maximum gray value increases, when the calculated power consumption of the frame is higher than the reference value.

3. The display device of claim 1, wherein the voltage level determining unit is configured to maintain the voltage level of the driving power, when the calculated power consumption of the frame is lower than the reference value.

4. The display device of claim 1, wherein the voltage level determining unit is configured to decrease the voltage level of the driving power in a high power-consumption pattern, when the maximum gray values are the same.

5. The display device of claim 1, wherein the display device further comprises a power controller configured to control the power supply in accordance with voltage level signals applied from the voltage level determining unit.

6. A method of driving a display device comprising a plurality of pixels, a power supply configured to supply a driving power to the plurality of pixels, and a controller configured to generate power control signals for controlling the driving power, the method comprising:
analyzing image data on a frame by frame basis;
generating power control signals in accordance with the analyzed image data; and
supplying the driving power adjusted in accordance with the generated power control signals to the plurality of pixels.

7. The method of claim 6, wherein the analyzing the image data comprises:
calculating power consumption of the image data forming a frame;
calculating a maximum gray value of the image data forming the frame; and
determining a voltage level of the driving power based on the calculated power consumption and maximum gray value.

8. The method of claim 7, wherein the determining of the voltage level of the driving power comprises adjusting the voltage level of the driving power in accordance with the maximum gray value, when the calculated power consumption is higher than a reference value.

9. The method of claim 8, wherein the adjusting of the voltage level of the driving power comprises increasing the voltage level of the driving power as the maximum gray value increases.

10. The method of claim 8, wherein the adjusting of the voltage level of the driving power comprises decreasing the voltage level of the driving power in a high power-consumption pattern, when the maximum gray values are the same.

11. The method of claim 7, wherein the determining of the voltage level of the driving power comprises maintaining the voltage level of the driving power, when the calculated power consumption is lower than a reference value.
